(19) United States
(12) Patent Application Publication
(10) Pub. No.: US 2009/0127210 A1
(43) Pub. Date: May 21, 2009

(54) Method and apparatus for water remediation

(76) Inventor: Anthony E. Swisher, Waskom, TX (US)

Correspondence Address: John M. Harrison, 2139 E. Bert Kouns, Shreveport, LA, 71105, US

(21) Appl. No.: 11/986,050

(22) Filed: Nov. 20, 2007

(51) Int. Cl. C02F 1/52; C02F 1/50

(52) U.S. Cl. 210/764; 210/702; 210/739

(57) ABSTRACT

A method and apparatus for water remediation in general and particularly, for killing bacteria, algae and other microorganisms in water used to fracture-stimulate oil and gas wells and using a coagulant and/or a flocculant for removing the dead microorganisms. A biocide is first introduced into a pit or tank containing the water to be treated and after the microorganisms are dead, the flocculent is added to the biocide-treated water to remove the dead microorganisms. Sequential introduction of the biocide and flocculant into the water to be treated may be accomplished by a number of techniques and after each biocide application the water is tested to determine the remaining living microorganism concentration. The clarity of the treated water is then determined after removal of the dead microorganisms from the water using the flocculant. Recycle and circulation pumps are used in combination with treatment tanks, stationary and movable booms and other equipment to sequentially introduce the biocide and the flocculant into the pit or tank and diffuse these chemicals in the water.

### BACKGROUND OF THE INVENTION

### Field of the Invention

Water used to fracture-stimulate oil and gas wells is typically characterized by fresh water which may be brought to the well area by truck or pipe or from a water source on location. The water may also include saltwater and/or other chemicals, such as clay stabilizers, corrosion inhibitors, friction reducers and gelling agents. Prior to and in the course of use, and while standing in the pit, tank or like reservoir or container, the water becomes contaminated with bacteria, algae and other microorganisms which degrade fracturing visosifiers, cause corrosion and plug flow paths in the producing reservoir. Accordingly, it is desirable to remove the bacteria, algae and microorganisms from the fracture-stimulate water in order to minimize operational problems associated with well treatment.

### SUMMARY OF THE INVENTION

This invention relates to the treatment and remediation of various water and particularly, water used to fracture-stimulate oil and gas wells, by initially treating the water (typically water or water compositions) with a biocide which is specific to the bacteria, algae or microorganisms (hereinafter called microorganisms) in the water, to kill the microorganisms. Once the microorganism kill is determined by testing the biocide-treated water, the water is treated with a coagulant, flocculant or flocculants to induce precipitation of the microorganisms in the pit, tank or other water container, clarify the water and present a substantially clear treatment water. A number of different types of equipment can be utilized to achieve the respective biocide/flocculant infusion into the water to be treated, including circulation pumps; mixing containers which receive a stream of the water to be treated and first, the biocide and later the flocculant; stationary and movable booms which serve as spargers to distribute the treated water uniformly in a pit; and associated equipment. The biocide and flocculant additives can be sequentially added to and diffused in water to be remediated in a treatment vessel, pit or tank by dumping the additives in the vessel, pit or tank or directly in the water flow line by use of one or more mixers or a hopper and auger combination or a venturi and hopper apparatus and by pumping and other techniques disclosed herein and known to those skilled in the art. Testing of the biocide-treated water is typically effected by tests known to those skilled in the art for determining the microorganism kill and the efficiency of removal of these dead microorganisms by a flocculant or coagulant is typically determined by procedures such as ajar test. Depending upon the results of the jar test, more flocculant or coagulant may be added to further remove microorganisms killed by the biocide.

### BRIEF DESCRIPTION OF THE DRAWINGS

The invention will be better understood by reference to the accompanying drawings, wherein:

FIG. 1 is a schematic of a typical water remediation apparatus or system of this invention, which includes a submerged boom provided with openings for introducing a treated water into a pit containing a body of water to be treated and a recycle pump and a mixing tank, wherein water to be treated is recycled or recirculated by the pump from the pit, through the mixing tank and back into the pit through the boom, to first diffuse the biocide additive and later a flocculant or coagulant additive into the pit water;

FIG. 2 is a schematic of a mixing tank and an auger and hopper system for introducing biocide or a flocculant into water to make a pumpable concentrate in a mixing tank;

FIG. 3 is a schematic of a mixing tank and a venturi and hopper system for first introducing biocide or a flocculent into water to make a pumpable concentrate in a mixing tank;

FIG. 4 is a schematic of a mixing tank and a treatment pump for first pumping biocide or a coagulant from a drum or respective drums into the water in the mixing tank to make a pumpable concentrate;

FIG. 5 is a schematic of a mixing tank fitted with a venturi and hopper combination for pneumatically feeding a biocide or flocculant from the hopper into the mixing tank to create a chemically concentrated water solution;

FIG. 6 is a schematic of a pit containing water to be treated, a submerged boom and a recycle pump connected to the boom and to a venturi and hopper combination for first introducing a biocide additive and then a flocculant or coagulant additive into the pit water through the submerged boom by operation of the venturi;

FIG. 7 is a schematic of a recycle pump, mixer and pit for introducing untreated or partially-treated water from the pit into a movable boom after adding biocide and flocculant/coagulant additives into the water, wherein the boom can be moved from one end of the pit to the other, to disperse the resulting chemically-concentrated solution into all areas of the pit;

FIG. 8 is a schematic of a mixer, recycle pump and a circulation pump positioned near a pit containing water to be treated and a boom immersed in the water, wherein the recycle pump circulates untreated or partially-treated water from the pit to a point of infusion of a biocide and flocculant/coagulant, through the boom and back into the pit and the circulation pump circulates the water in the pit;

FIG. 9 is a schematic of a pair of mixers in association with a pit or tank, wherein the additive biocide and flocculant or coagulant are introduced directly into the mixers in a water stream flowing through the mixers into the pit or tank;

FIG. 10 is a schematic of a mixer in association with a pit or tank containing water to be treated, wherein the additive biocide and flocculant or coagulant are introduced directly into a mixer in a water stream flowing from a tank truck through the mixer into the pit or tank;

FIG. 11 is a schematic of a mobile mixing truck and separate mixer in association with a pit or tank, wherein the additive biocide and flocculant are introduced from a solution in the mobile mixer and then through another mixer in a water stream flowing from the mobile mixer mobile through the second mixer into the storage pit or tank;

FIG. 12 is a schematic of a pit or tank from which water is pumped through a first mixer for first receiving a biocide and/or a flocculant or coagulant and to a second mixer for receiving additional biocide and/or flocculant, as needed and then directly to the well or to a tank;

FIG. 13 is a schematic of a bulk biocide and flocculant or coagulant container, truck or the like for sequential use and fitted with an air or water access for sequentially forcing the contents of the container into a pit containing water to be treated by introduction of the air or gas stream into the container;

FIG. 14 is a schematic of a pit fitted with a mixer and a sprayer, sprinkler or sparger system containing sparger nozzles or openings for circulating untreated or partially-treated water from a pit or reservoir through a mixer, where a biocide or flocculant coagulant is added, and then through the sparger and back into the storage pit by a recycle pump and further circulating the water using an optional secondary circulation pump provided to circulate the pit and diffuse the biocide and flocculant/coagulant additives into the water; and

FIG. 15 is a schematic of a pit fitted with a mixer and a spray head or a nozzle connected to the discharge line of a recycle pump for circulating untreated or partially treated water from a storage pit back into the pit using the spray head or nozzle, with an optional secondary circulation pump provided to further circulate the pit and diffuse the biocide and flocculant/coagulant additives into the water.

### DESCRIPTION OF THE PREFERRED EMBODIMENTS

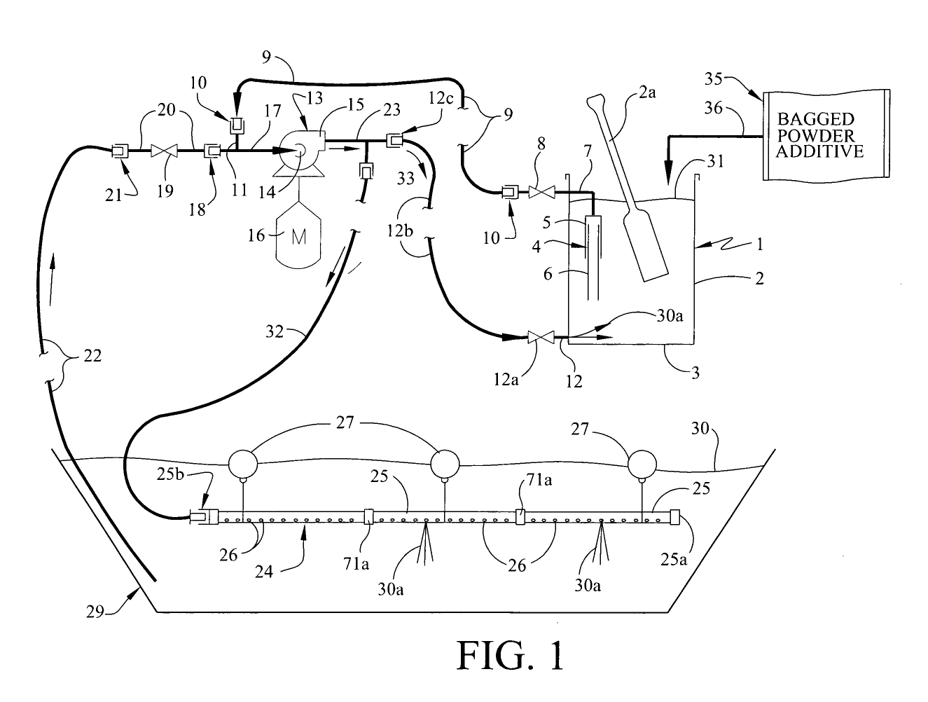

Referring initially to FIG. 1 of the drawings, in one embodiment of the invention the water used to fracture-stimulate oil and gas wells is located in a pit 29 and is generally designated by reference numeral 30 as pit water, reference numeral 30a as circulated, chemically partially-concentrated water and reference numeral 31 as chemically super-concentrated water. Both the chemically partially-concentrated water and chemically super-concentrated water have varying concentrations of either or both of the biocide and flocculent or coagulant additives designated by reference numeral 35. A boom 24 typically includes several lengths of boom pipe 25 of selected size, typically connected by quick disconnect or threaded pipe connectors 71a and is typically submerged in the pit water 30 and maintained in the submerged condition by boom floats 27. Each length of the boom pipe 25 is provided with spaced-apart pipe nozzles or openings 26 and one end of a boom hose 32 is connected to the boom 24 at a pipe hose connection 25b. The opposite end of the boom 24 from the pipe hose connection 25b is typically closed by a pipe cap 25a. The opposite end of the boom hose 32 from the pipe hose connection 25b is connected to a pump discharge line 23, typically at a boom hose connection 33. The pump discharge line 23 is connected at one end to the recycle pump discharge 15 of a recycle pump 13, while the opposite end of the pump discharge line 23 is attached to a tank intake hose 12b, typically at a tank intake hose connection 12c. The opposite end of the tank intake hose 12b is typically connected to a tank intake line valve 12a, which also connects to a tank intake line 12, fitted in the bottom of the typical cylindrical wall 2 of a mixing tank 1, having a tank bottom 3. A tank suction pipe 4 is submerged in a quantity of chemically super-concentrated water 31 contained in the mixing tank 1, and the tank suction pipe 4 typically includes a telescoping suction pipe 6, slidably fitted in a fixed suction pipe 5, to vary the outward flow of the chemically super-concentrated water 31 from the mixing tank 1, through a tank suction line 7, connected to the fixed suction pipe 5 of the tank suction pipe 4. A tank suction line valve 8 is fitted in the tank suction line 7 and is connected to one end of a tank recycle hose 9, typically at a tank recycle hose connection 10. The opposite end of the tank recycle hose 9 is fitted to a tank recycle hose nipple 11, typically at a second tank recycle hose connection 10 and the tank recycle hose nipple 11 is, in turn, connected to a recycle pump suction line 17 that terminates at the recycle pump suction 14 of the recycle pump 13. A typically gasoline recycle pump motor 16 drives the recycle pump 13. A suction connecting segment 20 contains a recycle pump suction line valve 19 and has one end connected to the recycle pump suction line 17 and the opposite end attached to a pit suction hose 22, typically by recycle pump suction line hose connection 18 and segment hose connection 21, respectively. The opposite end of the pit suction hose 22 is immersed in the pit water 30 located in the pit 29. Accordingly, additives 35, which may typically be a powder, granule or a liquid, are introduced into the mixing tank 1, either directly by dumping or through an additive intake line 36 and stirred, either mechanically as hereinafter further described, or by hand, using a paddle 2a.

According to the above described embodiment of the invention, the first additive 35 is initially introduced into the mixing tank 1 to define the chemically super-concentrated water 31, as a biocide designed to kill specific bacteria, algae and other microorganisms located in the pit water 30. The biocide or biocides are initially tested on the bacteria, algae and other microorganisms (hereinafter called microorganisms) and a specific biocide or biocides is chosen for introduction into the mixing tank 1. Other chemicals can also be added to the chemically super-concentrated water 31 to adjust the PH or otherwise alter the physical characteristics of the chemically super-concentrated water 31 to enhance the effect of the biocide(s), as hereinafter described. When the chosen biocide or biocides is introduced into the mixing tank 1, the recycle pump suction line valve 19, tank suction line valve 8 and tank intake line valve 12a are opened, the recycle pump 13 is energized and the chemically super-concentrated water 31 in the mixing tank 1 is pumped through the telescoping suction pipe 6 and fixed suction pipe 5 of the tank suction pipe 4. From this point it is pumped through the tank suction line valve 8 from the tank suction line 7, into the recycle pump suction line 17 and then into the recycle pump suction 14 of the recycle pump 13. Chemically partially-concentrated water 30a is then pumped from the recycle pump discharge 15 through the pump discharge line 23 and this stream is split into a first stream flowing through the boom hose 32 and a second stream flowing through the intake hose 12b and back through the tank intake line valve 12a, into the mixing tank 1. The stream of chemically partially-concentrated water 30a flows through the boom hose 32 and is directed through the pipe hose connection 25b on one end of the boom 24 and dispersed into the pit water 30 in the pit 29, through the spaced-apart pipe nozzles or openings 26 in the connected segments of the boom pipe 25. Accordingly, the pit water 30 becomes mixed, diffused and infused with chemically partially-concentrated water 30a, which has been diluted from chemically super-concentrated water 31 from the mixing tank 1 to the chemically partially-concentrated water 30a. This recirculation continuously raises the chemical concentration of the pit water 30 which is circulated back to the recycle pump 13 through the pit suction hose 22. The pit suction hose 22 is connected to one end of the suction connecting segment 20, which receives the recycle pump suction line valve 19, and the opposite end of the suction connecting segment 20 terminates in the recycle pump suction 14 of the recycle pump 13. Continued circulation of the mixed biocide additive 35 and the chemically super-concentrated water 31 in this manner insures that the pit water 30 will ultimately be fully infused with and treated by the biocide additive 35 and the microorganisms located in the pit water 30 killed by the biocide.

In the second phase of the invention, after sufficient time is allowed for the selected biocide or biocides to kill the microorganisms in the pit water 30 in the pit 29 as heretofore described, the water is tested to determine the remaining concentration of live microorganisms, if any. After the desired microorganism kill is determined, a flocculant or coagulant (hereinafter called flocculant) is added as an additional additive 35. The flocculant additive 35 is typically introduced into the mixing tank 1 through the additive line 36 in the same manner as the biocide(s) and is mixed in the mixing tank 1, typically using a mechanical mixer 37 or a paddle 2a, as described above with respect to the biocide mixing procedure. The chemically super-concentrated water 31 which now includes the flocculant and the dead microorganisms killed by the biocide, is then introduced into the supply of pit water 30 in the pit 29 through the tank suction pipe 4, the tank recycle hose 9, the recycle pump suction line 17, the recycle pump 13, the pump discharge line 23 and the boom hose 32, in the manner described above with respect to the biocide treatment. The flocculant is thus introduced into the pit water 30 in the pit 29 through the boom hose 32, the boom 24 and the pipe openings 26. The flocculant is continually added to the pit water 30 in the pit 29 until the proper concentration is achieved by circulating the increasingly concentrated pit water 30 through the pit suction hose 22, the suction connecting segment 20, the recycle pump suction line 17 and into the recycled pump suction 14 of the recycle pump 13. If necessary, an additional type of flocculant can be added, typically in the manner described above. The flocculant serves to precipitate the microorganisms killed by the biocide treatment to the bottom of the pit 29 and clarify the flocculated and biocide-treated pit water 30, typically to facilitate use of the clarified pit water as a fracture-stimulant medium for oil and gas wells (not illustrated) in the course of pumping the water downhole in the well according to conventional techniques. The clarity of the flocculated and biocide-treated pit water 30 is tested after application of the flocculant to determine whether additional flocculation is necessary. The diffusion and infusion of both the biocide and flocculant additives into the pit water 30 is aided by natural convections of the water due to environmental heating and cooling.

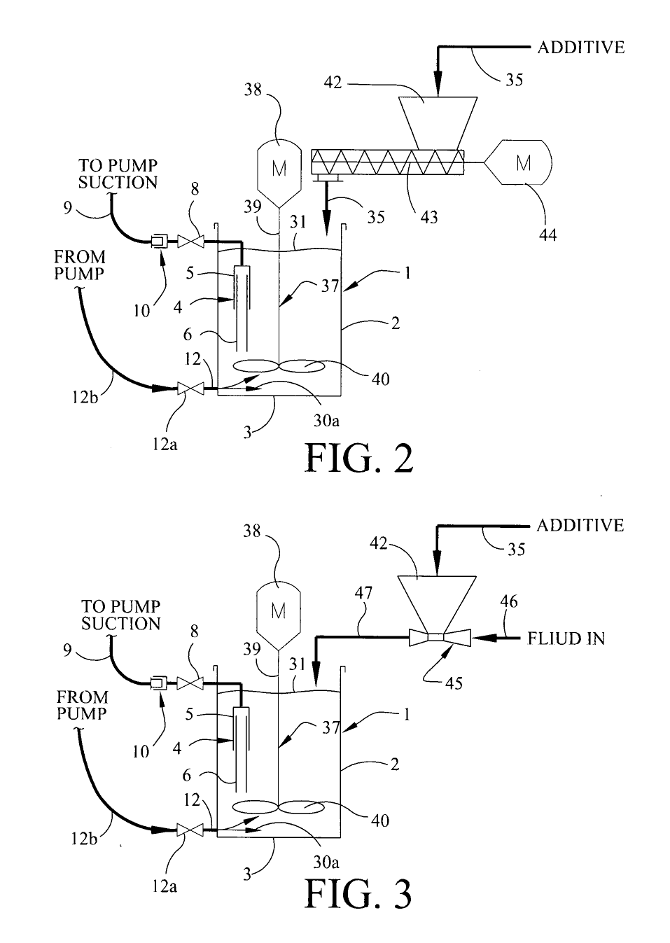

Referring now to FIG. 2 of the drawings, it will be appreciated by those skilled in the art that both the biocide and the flocculant additives 35 may be sequentially introduced into the mixing tank 1 by various techniques. Typical of these techniques is the use of an auger 43, extending from a hopper 42 and including an auger motor 44, attached to the auger 43 for rotating the auger flutes inside a casing. A typically dry biocide additive 35 is initially introduced into the hopper 42 and is fed from the hopper 42 through the auger 43, driven by an auger motor 44. The biocide additive 35 is thus introduced in a desired quantity into the mixing tank 1 at the terminal or discharge end of the auger 43 positioned over the mixing tank 1 and is mixed in the chemically super-concentrated water 31 in the mixing tank 1 as heretofore described. The resulting chemically super-concentrated water 31 is then caused to flow from the mixing tank 1 through the recycle pump 13 illustrated in FIG. 1 and from there into the pit water 30 in the pit 29, further illustrated in FIG. 1. The pit water 30 is then pumped to the recycle pump 13, through the pit suction hose 22, as described above with respect to FIG. 1 of the drawings. As further illustrated in FIG. 2, a mechanical mixer 37 may be positioned such that the mixer shaft 39 and mixer blades 40 extend into the chemically super-concentrated water 31 and the mixer motor 38 is activated to rotate the mixer blades 40 at a selected speed and diffuse and blend the biocide additive 35 into the chemically super-concentrated water 31 in the mixing tank 1. After sufficient time is allowed for killing of the various microorganisms located in the pit water 30 and the chemically super-concentrated pit water 31 by the biocide additive 35, and after a test or tests confirm the desired microorganism kill, a flocculant additive 35 is added to the hopper 42 and is distributed by means of the auger 43 into the mixing tank 1 for mixing with the chemically super-concentrated water 31, typically by operation of the mechanical mixer 37. The resulting chemically super-concentrated water 31 is then diluted with water from the pit 29 and a portion of this chemically partially-concentrated water 30a is returned to the mixing tank 1, while the rest of the water is circulated to the pit 29, using the recycle pump 13 and the boom 24, as described above with respect to FIG. 1 of the drawings. As further described above with respect to FIG. 1 of the drawings, the now flocculated and biocide-treated pit water 30 is tested for clarity to determine whether additional flocculation is necessary.

Referring now to FIG. 3 of the drawings, in another embodiment of the invention the biocide and the flocculant additives 35 can be added in sequence to a hopper 42, which is mounted on a venturi 45, wherein air, water or an alternative fluid can be introduced into the venturi 45 and the resulting zone of low pressure formed in the venturi 45 facilitates an initial flow or movement of liquid or powdered biocide additive 35 and later, a flocculent additive 35, through the water outlet stream 47 and into the mixing tank 1. As in the case of the other embodiments in the invention, it will be appreciated that the biocide additive 35 is first added to the hopper 42 and dispensed into the mixing tank 1 to create the chemically super-concentrated water 31, using the venturi 45. The flocculant additive 35 is later added to the hopper 42 and is dispensed into the mixing tank 1 through the venturi 45 after additional time has elapsed to insure that the desired concentration of microorganisms located in the biocide-treated pit water 30 are dead. The resulting chemically super-concentrated water 31 is then diluted with water from the pit 29 and a portion is returned to the mixing tank 1 while the rest is circulated to the pit 29 using the recycle pump 13 and the boom 24, as described above with respect to FIG. 1 of the drawings. Testing of the flocculated and biocide-treated pit water 30 is effected as described above with respect to FIGS. 1 and 2 of the drawings.

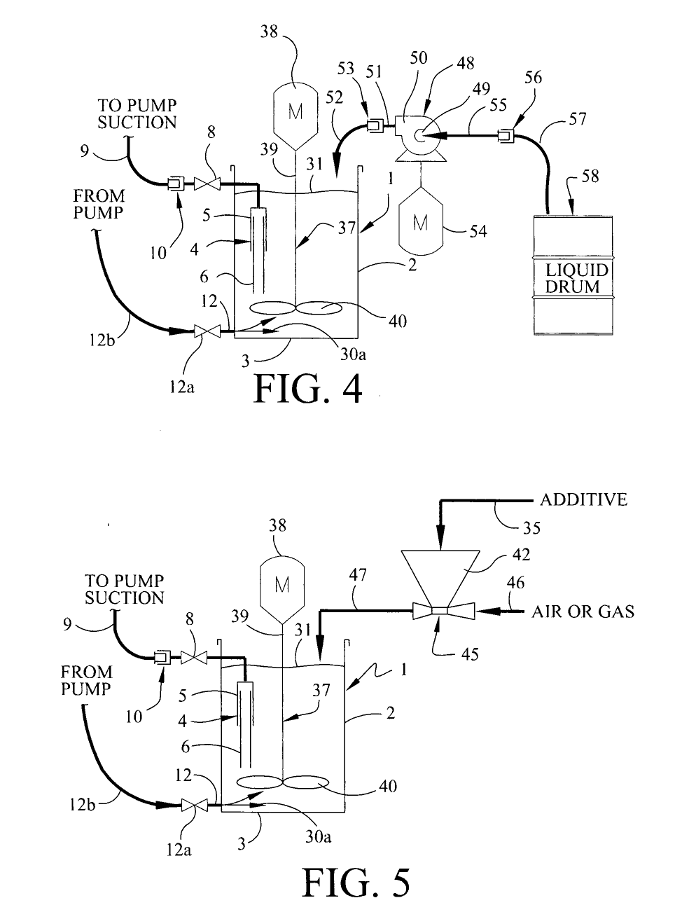

As illustrated in FIG. 4 of the drawings in another embodiment of the invention, the mixing tank 1 and mechanical mixer 37 combination illustrated in FIGS. 2 and 3 is utilized in connection with a treatment pump 48, fitted with a treatment suction hose 55, that extends from the treatment pump suction 49 to a treatment container hose 57, typically at a treatment suction hose connection 56. The treatment container hose 57 extends to a treatment container 58, such as a drum, for containing a biocide or flocculant additive. The biocide and later, the flocculant additive located in the treatment container(s) 58 is pumped through the treatment container hose 57 and the treatment suction hose 55 and the pump 48 and through a treatment pump discharge 50 and a treatment pump discharge line 51, connected to a treatment discharge hose 52, typically at a treatment discharge connection 53. The biocide and flocculant elements or additives are sequentially introduced into the mixing tank 1 at selected time intervals to first treat the pit water 30 and kill the microorganisms and then flocculate the dead microorganisms, after the additives have been thoroughly mixed and diffused with the pit water 30. Recirculation of the now flocculated and treated pit water 30 through a pit 29, using a recycle pump 13 and boom 24 is typically accomplished as described above with respect to FIG. 1 of the drawings. A typically gasoline pump motor 54 drives the treatment pump 48, as further illustrated in FIG. 4.

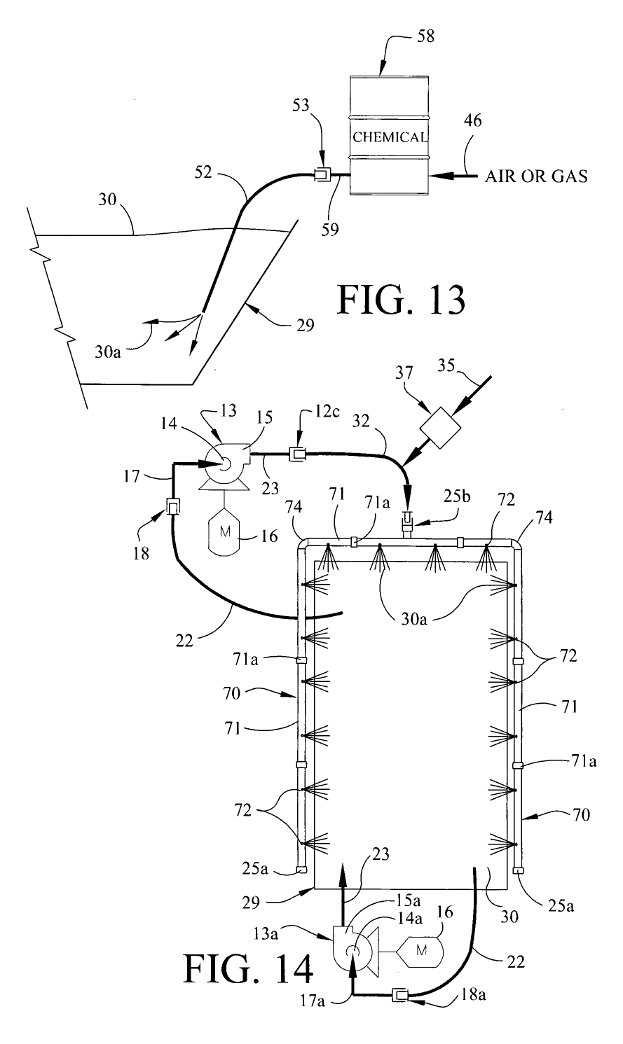

As illustrated in FIG. 5 of the drawings, in another embodiment of the invention a mixing tank 1 is illustrated, having a typically cylindrical wall 2 and a tank bottom 3. The mixing tank 1 is fitted with a mechanical mixer 37, having a mixer shaft 39 and blades 40 extending into a quantity of chemically super-concentrated water 31 in the mixing tank 1. A tank suction pipe 4 is also provided in the mixing tank 1 and is submerged in the chemically super-concentrated water 31, wherein a telescoping suction pipe 6 is slidably fitted in a fixed suction pipe 5 to adjust the rate of flow of chemically super-concentrated water 31 through the tank suction pipe 4 and into the recycle pump suction 14 of a recycle pump 13 ( illustrated in FIG. 1). Referring again to FIG. 1, a portion of the chemically partially-concentrated pit water 30a is circulated back into the mixing tank 1 as it is discharged from the recycle pump discharge 15, through the tank intake hose 12b and the tank intake line valve 12a, into the bottom of the mixing tank 1. A biocide and later, a flocculant, are typically sequentially introduced to the mixing tank 1 as successive additives 35, by fluidizing the additive 35 with an air stream, typically inside a pressurized treatment container 58 (FIG. 13) so that the additive 35 can be transported by pressure over the chemically super-concentrated water 31 in the mixing tank 1. When the resulting chemically super-concentrated water 31 is treated with the biocide and has been circulated back to the tank or pit as described with respect to FIG. 1 of the drawings, a flocculant additive 35 is introduced into the treatment container 58 (FIG. 13) and is similarly directed into the chemically super-concentrated water 31 in the mixing tank 1, also by operation of the typically air or gas flowing through the gas inlet line 46 and the treatment container nipple 59 (FIG. 13).

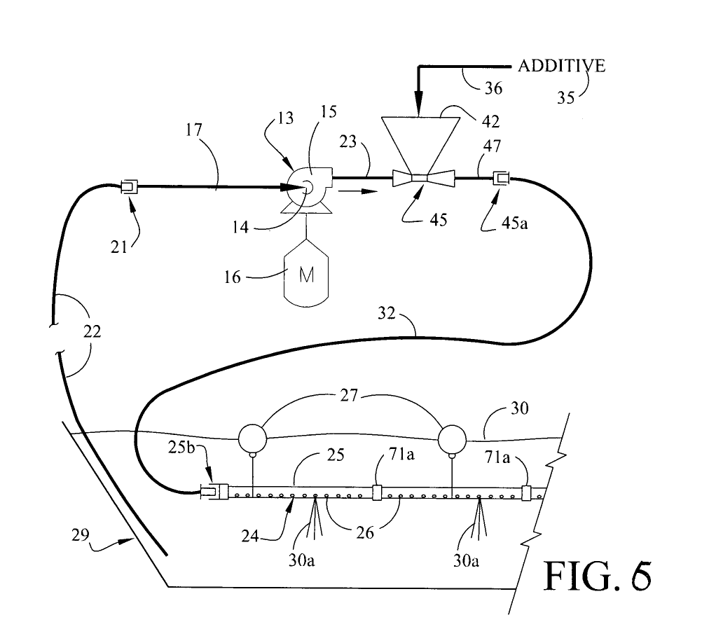

Referring now to FIG. 6 of the drawings, in still another embodiment of the invention a venturi 45 is added to the pump discharge line 23 extending from the recycle pump discharge 15 of a recycle pump 13. The venturi 45 is connected to a water outlet line 47, attached to a boom hose 32, typically by a venturi connection 45a. The opposite end of the boom hose 32 is attached to one end of the boom 24 at a pipe hose connection 25b, for introduction of a biocide and later, a flocculant additive 35, into the hopper 42, through an additive line 36. As in the embodiments described above with respect to FIG. 1, the initial additive 35 is a biocide for killing the microorganisms in the pit water 30 and later after testing the biocide-treated pit water 30 a flocculant additive 35 is introduced for precipitating the dead microorganisms and clarifying the flocculated treated pit water 30 to a tested degree of clarity. A recycle pump suction line 17 extends from the recycle pump suction 14 of the recycle pump 13 to a segment hose connection 21, which attaches a pit suction hose 22 to the recycle pump suction line 17. The opposite end of the pit suction hose 22 extends into the pit water 30 in the pit 29, where the boom 24 is submerged in the pit water 30, typically using boom floats 27. Accordingly, when it is desired to introduce a biocide additive 35 into the pit water 30 and the pit 29, the typically powdered, pelletized or granulated biocide additive 35 is initially introduced into the additive line 36, and from there into the hopper 42, where it flows with the pit water 30 (pumped from the pit 29 through the pit suction hose 22 and recycle pump suction line 17, through the recycle pump 13 into the pump discharge line 23) and through the venturi 45, through the boom hose 32 and the boom 24, as chemically partially-concentrated water 30a. Mixing of the biocide additive 35 with the pit water 30 is thus accomplished without the use of the mixing tank 1 illustrated in FIGS. 1-5 of the drawings. When a sufficient quantity of biocide additive 35 is provided in the pit water 30 to sufficiently treat the pit water 30 and kill the microorganisms therein, a flocculant additive 35 is pumped or introduced into the additive line 36 and the hopper 42, for distribution by means of the venturi 45 in the same manner as the biocide previously introduced into the pit water 30. The flocculant additive 35 in the pit water 30 precipitates the dead microorganisms and clarifies the flocculated and biocide-treated pit water 30 for more efficient use in the fracturing operation.

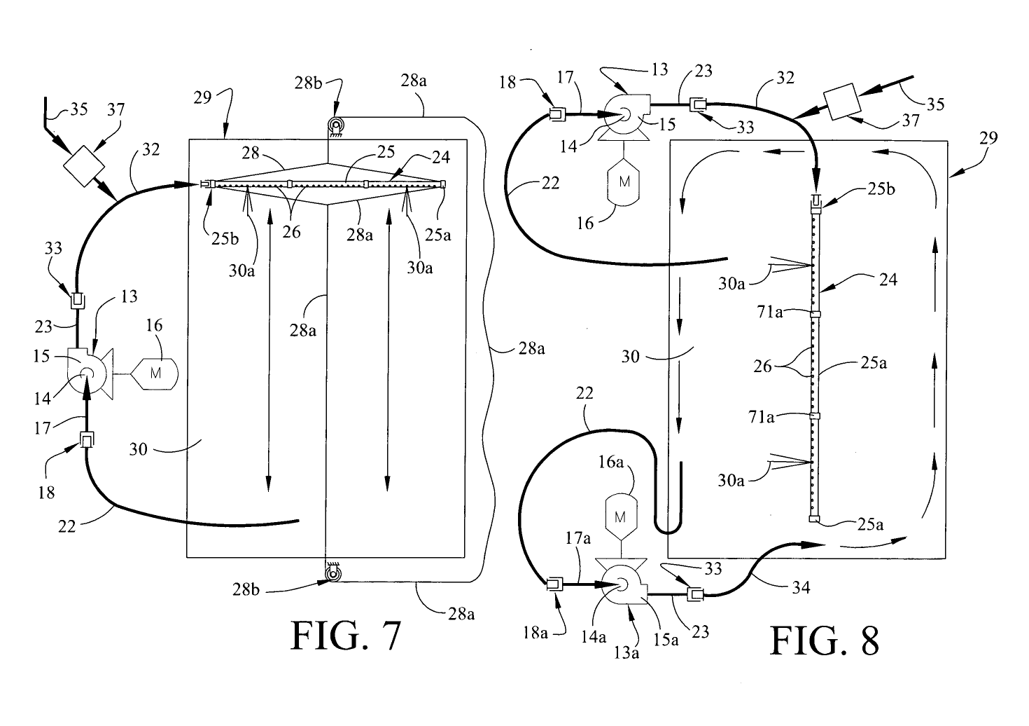

Referring now to FIG. 7 of the drawings, in still another embodiment of the invention a pit 29 is fitted with a boom harness 28, extending from a boom 24 and provided with a boom control line 28a, which extends from the boom 24 around a first boom pulley 28b and from the first boom pulley 28b to a second boom pulley 28b located at the opposite side of the pit and from there across the pit 29, back to the boom harness 28. This mechanical arrangement facilitates movement of the boom 24, either in a submerged condition as illustrated in FIGS. 1 and 6 or on the surface of the pit water 30 located in the pit 29, by tension applied to the boom control line 28a, to more evenly distribute biocide and later flocculant additives 35 from the mixer 37, through the boom 24 and the pipe openings 26 in the boom pipe 25 and into the pit water 30. Recirculation of the pit water 30 is typically accomplished using a recycle pump 13, which discharges the pit water 30 through a pump discharge line 23, typically connected to a boom hose 32 by a boom hose connection 33. The pit water 30 is pumped from the pit 29 through a pit suction hose 22 having one end connected to a recycle pump suction line 17 (typically at a recycle pump suction line hose connection 18) that extends to the recycle pump suction 14 of the recycle pump 13. The opposite end of the pit suction hose 22 is immersed in the pit water 30 in the pit 29.

Accordingly, a biocide additive 35 can be initially introduced into the pit water 30 using a mixer 37 of any chosen design and the chemically partially-concentrated water 30a then pumped through the boom 24 to diffuse and disperse the biocide therein, using the recycle pump 13 and boom 24, as illustrated in FIG. 6. The boom 24 is typically moved at a desired rate from one end of the pit 29 to the other using the boom harness 28 and the boom control line 28a, extended around the oppositely-disposed, spaced-apart boom pulleys 28b. After laboratory tests confirm that the microorganisms in the biocide-treated pit water 30 are dead, a flocculent additive 35 is introduced into the biocide-treated pit water 30 in any desired manner, but typically using the mixer 37 or any of the techniques described herein, to define a flocculated and biocide-treated pit water 30.

Referring now to FIG. 8 of the drawings, in another embodiment of the invention a recycle pump 13 can be provided near a pit 29 containing a quantity of pit water 30 as described with respect to FIG. 7, while a circulation pump 13a is typically also located near the pit 29, for thoroughly circulating and mixing the pit water 30, which is first treated with a biocide additive 35 and later a flocculant additive 35, typically introduced therein using a mixer 37, as described above with respect to FIG. 7. The recycle pump 13 is typically provided with a pump discharge line 23, connected to a boom hose 32, which is connected to the mixer 32, typically using a boom hose connection 33 and the extending end of the boom hose 32 is secured to one end of a boom 24, typically using a pipe hose connection 25b, as described above. As further described above, the boom 24 is typically submerged or floating on the body of pit water 30 and is typically constructed of segments of boom pipe 25 joined at pipe connectors 71a, which may be quick-disconnect or threaded pipe connectors, as desired. A pit suction hose 22 has one end immersed in the pit water 30 in the pit 29 and the opposite end connected to a recycle pump suction line 17, typically at a recycle pump suction line hose connection 18. Accordingly, the recycle pump suction line 17 extends to the recycle pump suction 14, while the pump discharge line 23 extends from recycle pump discharge 15 of the recycle pump 13, to pump and circulate the pit water 30 from the pit 29 through the pit suction hose 22 and the recycle pump suction line 17, recycle pump 13, pump discharge line 23 and the boom hose 32 and back into the reservoir of pit water 30, through the pipe openings 26 in the boom pipe 25 of the boom 24, to diffuse the respective biocide and flocculent additives into the resulting flocculated and biocide-treated pit water 30, as described above with respect to FIG. 7 of the drawings.

In like manner, the circulation pump 13a pumps the pit water 30 through a second pit suction hose 22 located therein, and through a circulation pump suction line connection 18a and a circulation pump suction line 17a, into the circulation pump suction 14a and from the circulation pump discharge 15a of the circulation pump 13a. The circulated pit water 30 then flows through a second pump discharge line 23 and into the reservoir of pit water 30, through a pit discharge hose 34. The flocculated and biocide-treated pit water 30 is therefore also circulated in the pit 29 using the circulation pump 13a. Accordingly, mixing and diffusion of the biocide and later the flocculant in the pit water 30 is thus achieved by the recycle pump 13, boom 24 and a first pit suction hose 22, as well as the circulation pump 13a, using the pit discharge hose 34 and a second pit suction hose 22. Testing of the flocculated and biocide-treated pit water 30 for biocide kill and flocculation efficiency, respectively, of the microorganisms in the pit water is effected as detailed herein.

Referring now to FIG. 9 of the drawings, it will be appreciated by those skilled in the art that in a still further embodiment of the invention, water of desired quality from a selected source can be pumped to a first mixer 37 of selected design and a biocide additive 35 initially added to the mixer 37 as heretofore described, for distribution to a second mixer 37. A flocculent additive 35 is then added to the biocide-treated water in the second mixer 37, and the flocculated and biocide-treated water is directed into a pit 29 or a tank, typically through a treatment discharge hose 52. A pump (not illustrated) is typically used for this purpose. It will be further understood that the pit 29 can be replaced by a tank such as a frac tank, holding tank or other container for receiving and storing the treated water. An additional mixer or mixers 37 of selected design can be added to the treatment system for adding additional biocide and/or flocculent additives 35, as deemed necessary.

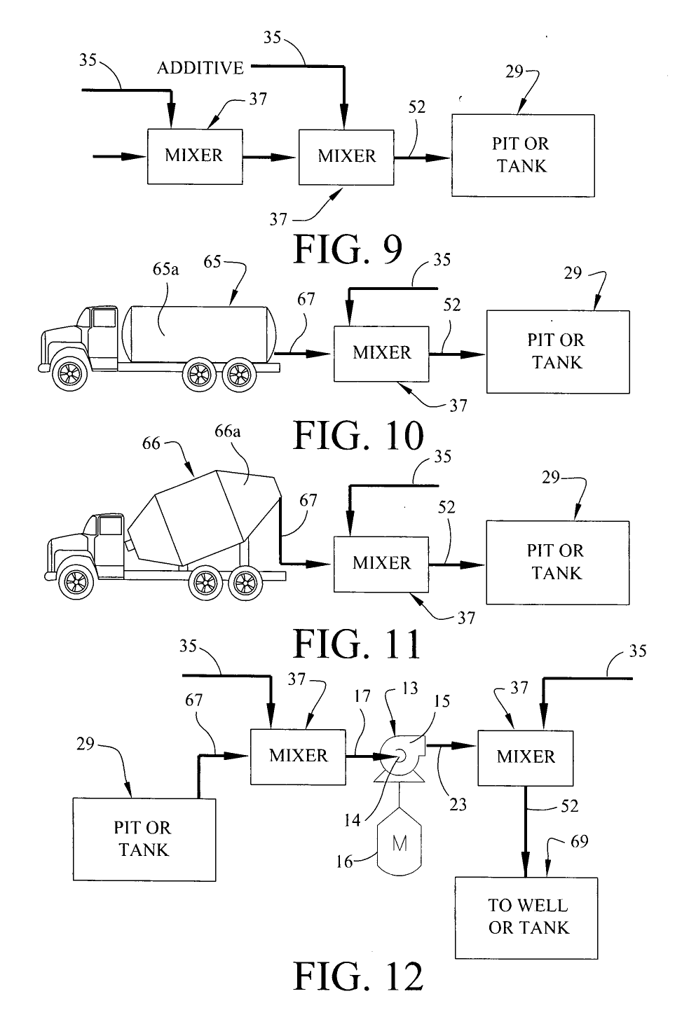

Referring now to FIG. 10 of the drawings, in another embodiment of the invention a tank truck 65 has a truck tank 65a which carries a supply of water and is connected to a mixer 37, typically by a tank discharge line 67. If the water in the truck tank 65a has not previously been treated with a biocide and/or a flocculant additive 35, or if additional biocide and/or flocculant is needed, a biocide additive 35 and/or flocculant additive 35 are sequentially introduced into the mixer and the resulting treated water mixture is directed through a treatment discharge hose 52 into a pit or a tank 29. Under circumstances where the water from the truck tank 65a has not been previously treated with a biocide and/or flocculant or has only been partially so treated, and after a sufficient quantity of the biocide additive 35 is introduced into the mixer 37 and then pumped into the pit or tank 29, sufficient time is allowed for the biocide to kill the microorganisms in the water which has been treated. The flocculant additive 35 is then introduced into the mixer 37, mixed with the incoming water and discharged through the treatment discharge hose 52 into the pit or tank 29, to further treat the biocide-treated water, precipitate the dead microorganisms and clarify the concentrated flocculated biocide-treated water. The water is typically pumped from the tank truck 65 into the mixer 37 and the pit or tank 29 by a pump (not illustrated) which may be mounted on the tank truck 65.

As illustrated in FIG. 11 of the drawings, in a still further embodiment, a similar procedure can be used to treat a quantity of water of varying quality using a mixing truck 66 having a mixing tank 66a, which is filled with biocide and/or flocculant-treated water, which water is introduced into a mixer 37, typically through a tank discharge line 67. Successive charges of a flocculant additive 35 are typically sequentially introduced into the mixer 37 as needed and then into a pit or tank 29 via a treatment discharge hose 52, for clarifying the water in the pit or tank 29 in the manner detailed above with respect to FIG. 10 of the drawings. A pump (not illustrated) typically located on the mixing truck 66 may typically be used to pump the concentrated flocculated and biocide-treated water through the mixer 37, into the pit or tank 29.

Referring now to FIG. 12 of the drawings, in another embodiment of the invention a pit or tank 29 containing a quantity of untreated or biocide and/or flocculant-treated water typically used to fracture-stimulate oil and gas wells is coupled to a first mixer 37 through a tank discharge line 67 and a biocide and/or flocculant additive 35 is initially introduced as needed, into the first mixer 37 and mixed with the water from the pit or tank 29. The resulting treated water mixture is typically pumped by a pump 13 to a second mixer 37, where additional biocide and/or flocculant additive 35 may be added, if necessary. The flocculated biocide-treated water is then pumped through a treatment discharge hose 52, either directly to a well in a well service fracture operation (not illustrated) or to a discharge recipient such as a storage tank 69. As in the case of the embodiments heretofore described, the pump 13 is typically characterized by a pump suction 14 which receives the initially treated water from the first mixer 37 through the recycle pump suction line 17 and a pump discharge 15, which discharges the water into the second mixer 37 through a pump discharge line 23. Moreover, the treated water is first tested after application of the biocide additive 35 and second after the flocculant additive 35 is added, to determine the microorganism kill and water clarity, respectively, as described above. Alternatively, the biocide can be first added to the first mixer 37 and the incoming water from the pit or tank 29 and the flocculant added at a later time to the second mixer 37.

Referring now to FIG. 13 of the drawings, in yet another embodiment, a body of pit water 30, located in a pit 29 or in a tank or the like is remediated by initial introduction of a biocide chemical from a treatment container 58, through a treatment discharge hose 52 attached to a treatment container nipple 59, extending from the drum or treatment container 58 and typically coupled to the treatment discharge hose 52 by a treatment discharge connection 53. Air or gas may be introduced into the treatment container 58 through a typically gas inlet line 46 to force the typically dry biocide in the treatment container 58 through the treatment discharge hose 52 and into the pit water 30. Alternatively, the treatment container 58 may be positioned above the pit 29 as illustrated, to facilitate a gravity feed of the biocide when the biocide is a liquid. After the desired kill of microorganisms located in the pit water 30 is effected by the biocide and this kill typically is confirmed by testing the biocide-treated water 30, a flocculant component may be either added to the treatment container 58 or to a second treatment container 58 containing a dry flocculant and connected to the treatment discharge hose 52. A quantity of air or gas 46 is introduced into the treatment container 58 to force the dry flocculent through the treatment discharge hose 52 and into the biocide-treated pit water 30. As in the case of liquid biocide treatment, if the flocculant is also a liquid, the liquid flow of flocculant from the treatment container 58 to the pit 29 may be by gravity.

Referring now to FIG. 14 of the drawings, in another embodiment of the invention a sparger 70 is positioned on three sides of a pit 29 and includes multiple sparger pipes 71, joined by pipe connectors 71 a and elbows 74, which may be quick-disconnect pipe connectors or threaded pipe connectors, as desired. Pipe nozzles or openings 72 are provided in spaced-apart relationship with respect to each other in the sparger pipes 71, facing the pit 29 and one end of a boom hose 32 is connected to the sparger 70, typically at a pipe hose connection 25b. A mixer 37 of selected design is typically connected to the boom hose 32. The opposite end of the boom hose 32 is typically connected to the pump discharge line 23 of a recycle pump discharge 15 on a recycle pump 13, typically at a tank intake hose connection 12c. The recycle pump 13 is fitted with a recycle pump suction 14 that receives one end of a recycle pump line 17, the opposite end of which is connected to a pit suction hose 22, typically by means of a recycle pump suction line hose connection 18. The free end of the pit suction hose 22 is adapted for immersion in a quantity of pit water 30 which has either been treated with a biocide, typically in the manner disclosed herein, in the pit 29, or by using the mixer 37. In the latter case, a biocide additive 35 is added to the mixer 37 by any convenient method and typically by methods heretofore described. Operation of the recycle pump 13 causes pit water 30 to flow through the pit suction hose 22, the recycle pump suction line 17, the recycle pump 13 and from the recycle pump 13, through the pump discharge line 23 and the boom hose 32, through the sparger 70 and back into the pit 29, through the respective pipe nozzles or openings 72, as chemically partially-concentrated water 30a. A gasoline motor 16 typically drives the recycle pump 13 and a circulation pump 13a. In one aspect of this embodiment of the invention, the circulation pump 13a is provided to circulate the pit 29 and includes a pit suction hose 22, having one end immersed in the pit water 30 and the opposite end connected by a circulation pump suction line connection 18a to a circulation pump suction line 17a, which terminates at the circulation pump suction 14a of the circulation pump 13a. The pit water 30 pumped through the pit suction hose 22 and the circulation pump suction line 17a is also pumped back into the pit 29 through the circulation pump discharge 15a and the pump discharge line 23, as pit water 30. After testing of the biocide-treated pit water 30 indicates a desirable kill of microorganisms, a flocculent is typically added to the mixer 37 and the biocide-treated and circulated pit water 30 as an additional additive 35 (or directly to the pit water 30) to flocculate the dead microorganisms and clarify the resulting concentrated flocculated biocide-treated pit water 30. This water clarity is determined by testing, typically by the commonly used jar test. Diffusion and thorough infusion of both the biocide and flocculating additives 35 in the pit water 30 is typically achieved by using the recycle pump 13 and the circulation pump 13a. The sparger 70 can be positioned on only one side or end of the pit 29, along the entire or a portion of that end or side of the pit 29.

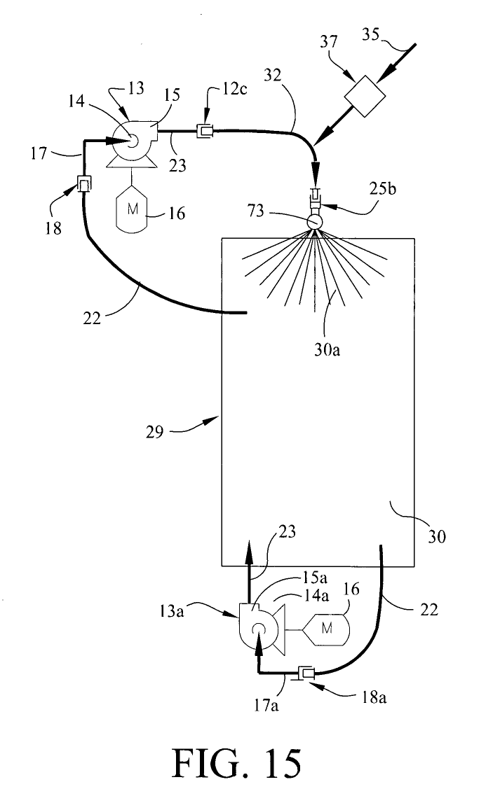

As illustrated in FIG. 15 of the drawings, in another embodiment of the invention a pit 29 contains a quantity of pit water 30 which is first treated in any convenient manner, but typically by adding a biocide additive 35 using a mixer 37. Later, after the microorganisms in the biocide-treated pit water have been killed by the biocide, a flocculant additive 35 is added. Initial mixing of the respective biocide and flocculant additives 35 with the pit water 30 is typically accomplished by the mixer 37 and diffusion of the additives 35 in the chemically partially-concentrated water 30a is effected, in part, by a recycle pump 13 having a pump discharge line 23 connected to a boom hose 32, typically using a tank intake hose connection 12c. The mixer 37 is typically connected to the boom hose 32. The opposite end of the boom hose 32 is connected to a pipe hose connection 25b and a spray head 73 is attached to the pipe hose connection 25b, to facilitate spraying of the chemically partially-concentrated water 30a back into the pit water 30 in the pit 29. Continued circulation of the pit water 30 through the recycle pump 13 is accomplished by a pit suction hose 22, having one end immersed in the pit water 30 and the opposite end connected to one end of a recycle pump suction line 17, typically by a recycle pump suction line hose connection 18. The opposite end of the recycle pump suction line 17 terminates at the recycle pump suction 14 of the recycle pump 13.

In a typical aspect of this embodiment of the invention a circulation pump 13a is provided for circulating the pit 29 and includes a pump discharge line 23 that communicates with the pit water 30 and with the circulation pump discharge 15a of the circulation pump 13a. One end of a pit suction hose 22 is immersed in the pit water 30 and the opposite end is attached to a circulation pump suction line 17a, which terminates at the circulating pump suction 14a and is typically connected to the pit suction hose 22 by a hose connection 18a. A gasoline motor 16 typically drives both the recycle pump 13 and the circulation pump 13a.

It will be appreciated by those skilled in the art that the fracture-stimulation water which may be treated according to the method of this invention is typically characterized by either fresh water which may be brought in by truck or pipeline, or from a water well or a source on location, or saltwater, which may be produced saltwater or water made salty by additives such as potassium chloride, sodium chloride, calcium chloride or other salts mixed with these components. Still other chemicals may be added to the “frac water” according to the stimulation needs in question and these may include such chemicals as clay stabilizers, corrosion inhibitors, friction reducers and gelling agents known to those skilled in the art. Moreover, typical fracture-stimulation water storage receptacles may include earthen or lined pits, as well as tanks, including mobile frac tanks permanent tanks and the like.

Moreover, substantially any water supply, including lake and pond water and well water, in non-exclusive particular, can be treated by the method of this invention according to the above disclosure. Accordingly, the water clarity and quality of these and other water sources can be improved under circumstances where this clarity and quality are reduced by the presence of microorganisms.

Biocides typically used in the water remediation method of this invention include powdered bromine; liquid or powdered or granular isothiazolin; liquid THPS (tetrakis (hydroxymethyl) phosphonium sulfate) powdered bronopol; powdered or granular DBNPA (dibromo-3-nitrilopropionamide) and chlorine, which may include chlorine gas, calcium hypochlorite, typically provided as granules, and sodium hypochorite, typically supplied as a liquid) and other commercially available biocides approved by the EPA. Other treatment chemicals that may be used in the invention to alter the PH and other characteristics of the water to be treated prior to treatment by the biocide are muratic, sulfuric and dry acids, as well as sodium carbonate and caustic soda, in non-exclusive particular.

Typical flocculants which may be used to flocculate the dead microorganisms killed by the biocide or biocide initially introduced into the water to be treated include anionic, non-ionic and cationic inorganic coagulant/flocculants such as aluminum sulfate, ferric chloride, ferric sulphate, polyaluminum chloride, aluminum chloride, polyaluminum hydroxychloride, aluminum chlorohydrate; ferrousulfatemonohydrate and hydrated lime, in non-exclusive particular. Organic polymers for use may typically include cationic, ionic and non-ionic chemicals such as polyacrylamide, polyamines and polydadmacs, in non-exclusive particular.

It is understood that additional steps other than settling or floating of the dead microorganisms, can be taken, including filtration and combinations of these methods, as desired or necessary. Moreover, the various mixers 37 may include the illustrated auger 43 and venturi 45, both in combination with a hopper 42, as well as other mixing devices such as tub mixers and the like, which are known to those skilled in the art.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A method of treating water containing microorganisms in a reservoir comprising the steps of circulating a first stream of the water to and from the reservoir; providing a treatment tank; diverting a portion of the first stream of water to the treatment tank; introducing biocide into the water in the treatment tank; circulating a second stream of water containing the biocide from the treatment tank into the first stream of water to kill microorganisms in the reservoir; and introducing a flocculant or coagulating agent into the water in the treatment tank to precipitate the microorganisms killed by the biocide in the reservoir.

2. The method of claim 1 comprising the step of testing the water in the reservoir after addition of the biocide to determine the concentration of living microorganisms remaining in the water.

3. The method of claim 2 comprising the step of delaying said testing of the water in the reservoir for a selected period of time after addition of the biocide before introducing the flocculant or coagulation agent into the water in the treatment tank.

4. The method of claim 1 comprising the step of placing a sparger or perforated boom in the reservoir and circulating said first stream of water through the sparger or perforated boom, and wherein said flocculant or coagulating agent comprises at least one flocculant or coagulant for flocculating the microorganisms killed by the biocide.

5. The method of claim 4 comprising the step of testing the water in the reservoir after addition of the biocide to determine the concentration of living microorganisms remaining in the water in the reservoir.

6. The method according to claim 5 comprising the step of delaying said testing of the water for a selected period of time after addition of the biocide before adding the flocculant into the water in the treatment tank.

7. The method of claim 1 comprising the step of mixing or stirring the water in the treatment tank and testing the water in the reservoir after addition of the flocculant or coagulating agent to determine the clarity of the water in the reservoir.

8. The method of claim 7 wherein said flocculant or coagulating agent comprises at least one flocculant or coagulating agent for flocculating the microorganisms killed by the biocide in the reservoir.

9. The method of claim 8 comprising the steps of placing a sparger or perforated boom in the reservoir and circulating said first stream of water through the sparger or perforated boom, and testing the water after addition of the biocide to determine the concentration of living microorganisms remaining in the water in the reservoir.

10. The method of claim 9 comprising the step of delaying said testing of the water for a selected period of time after addition of the biocide before adding the flocculant into the water in the treatment tank.

11. The method of claim 7 comprising the step of testing the water after addition of the biocide to determine the concentration of living microorganisms remaining in the water after the elapse of a selected period of time.

12. A method of treating water containing microorganisms in a reservoir comprising the steps of circulating the water from the reservoir back to the reservoir; introducing at least one biocide into the water to kill at least some of the microorganisms; waiting a preselected period of time; and introducing at least one flocculant or coagulating agent into the water to flocculate the microorganisms killed by the biocide and clarify the water in the reservoir.

13. The method of claim 12 comprising the step of testing the water after addition of the biocide and after said preselected period of time to determine the concentration of living microorganisms remaining in the water.

14. The method of claim 12 comprising the step of testing the water after addition of the flocculant or coagulating agent to determine the clarity of the water.

15. The method of claim 12 comprising the steps of:
(a) testing the water after addition of the biocide and after said preselected period of time to determine the concentration of living microorganisms remaining in the water; and
(b) testing the water after addition of the flocculant or coagulating agent to determine the clarity of the water.

16. The method of claim 15 comprising the step of placing a sparger or perforated boom in the reservoir and circulating the water through said sparger or perforated boom.

17. A method of treating water containing microorganisms in a reservoir comprising the steps of substantially continuously circulating the water from the reservoir and back to the reservoir; introducing at least one biocide into the water to kill at least some of the microorganisms in the water; waiting a preselected period of time; testing the water to determine the concentration of living microorganisms remaining in the water; introducing at least one flocculant or coagulant into the water to flocculate the microorganisms killed by the biocide and clarify the water; and re-testing the water to determine the clarity of the water.

18. The method of claim 17 comprising the step of placing a sparger or perforated boom in the reservoir and circulating the water through said sparger or perforated boom.

19. The method of claim 18 comprising the step of connecting the sparger or perforated boom to an adjusting mechanism and selectively moving the sparger or perforated boom in the reservoir responsive to operation of the adjusting mechanism.

20. The method of claim 17 comprising the step of providing at least one pump for said substantially continuously circulating the water from the reservoir and back into the reservoir.

21. The method of claim 20 comprising the step of placing a sprayer near the reservoir and circulating the water through said sprayer.

22. The method of claim 20 comprising the step of connecting a sparger or perforated boom to an adjusting mechanism and selectively moving the sparger or perforated boom in the reservoir responsive to operation of the adjusting mechanism.

23. The method of claim 20 comprising the steps of:
(a) placing a sparger or perforated boom in the reservoir and circulating the water through said sparger or perforated boom; and
(b) connecting the sparger or perforated boom to an adjusting mechanism and selectively moving the sparger or perforated boom in the reservoir responsive to operation of the adjusting mechanism.

24. A method for remediating water containing microorganisms in a reservoir comprising the steps of introducing a biocide into a first quantity of source water; introducing the first quantity of source water into the reservoir to kill the microorganisms in the water in the reservoir; introducing a flocculating or coagulating agent into a second quantity of the source water; and introducing the second quantity of source water into the reservoir to precipitate the microorganisms killed by the biocide.

25. The method of claim 24 comprising testing the water in the reservoir after addition of the first quantity of source water into the reservoir to determine the concentration of living microorganisms remaining in the water in the reservoir.

26. The method of claim 25 comprising the step of delaying said testing of the water in the reservoir for a selected period of time after addition of the first quantity of source water before introducing the flocculating or coagulating agent into the second quantity of source water and introducing the second quantity of source water into the water in the reservoir.

27. The method of claim 26 comprising the step of testing the water in the reservoir after introducing the second quantity of source water into the water in the reservoir to determine the clarity of the water in the reservoir.

28. The method of claim 24 comprising the step of providing at least one vehicle having a tank for containing the first quantity of source water and the second quantity of source water for introduction into the water in the reservoir.

29. A method for remediating water containing microorganisms comprising the steps of introducing a biocide into a quantity of water to kill the microorganisms in the water and introducing a flocculating or coagulating agent into the water to precipitate the microorganisms killed by the biocide in the water.

30. The method of claim 29 comprising testing the water after addition of the biocide in the water to determine the concentration of living microorganisms remaining in the water.

31. The method of claim 30 comprising the step of delaying said testing of the water for a selected period of time before introducing the flocculating or coagulation agent into the water.

32. The method of claim 31 comprising the step of testing the water after addition of the flocculant or coagulating agent to determine the clarity of the water.
